(19) United States
(12) Patent Application Publication
(10) Pub. No.: US 2026/0202602 A1
(43) Pub. Date: Jul. 16, 2026

(54) FRONT LIGHT MODULE AND DISPLAY DEVICE

(71) Applicant: E Ink Holdings Inc., HSINCHU (TW)

(72) Inventors: Kun-Hsien LEE, HSINCHU (TW); Ching-Huan LIAO, HSINCHU (TW); Hsin-Tao HUANG, HSINCHU (TW)

(21) Appl. No.: 19/437,312

(22) Filed: Dec. 31, 2025

Related U.S. Application Data
(60) Provisional application No. 63/745,292, filed on Jan. 14, 2025.

(51) Int. Cl. F21V 8/00; G02F 1/13357

(52) U.S. Cl. CPC G02B 6/0016; G02B 6/0043; G02F 1/133615

(57) ABSTRACT

A front light module includes a light guide plate, a light collecting structure and a light source. The light guide plate includes a top surface, a bottom surface, and a light incident surface connecting the top surface and the bottom surface, and a light extraction layer. The light extraction layer is located on at least one of the top surface and the bottom surface. The light collecting structure is located on the bottom surface of the light guide plate. The light source faces the light incident surface of the light guide plate.

### CROSS - REFERENCE TO RELATED APPLICATION

This application claims priority to US Provisional Application Serial Number 63/745,292, filed January 14, 2025, which is herein incorporated by reference in its entirety.

### BACKGROUND

### Field of Invention

The present invention relates to a font light module and a display device.

### Description of Related Art

The current E-paper products employee a light guide plate with micro structure dots in the front light module technique. However, such micro structure dot has the disadvantages of poor molding and optical performance instability.

As the thickness of the light guide plate decreases, the frequency of collisions between the edge-lit light and the dots on the light guide plate increases. Therefore, the dot density needs to be reduced. However, this approach will deteriorate the optical performance.

Accordingly, how to provide a front light module and a display device which can overcome aforementioned problems is still one of the develop direction for those in the industry.

### SUMMARY

One aspect of the present disclosure provides a front light module.

In one embodiment, the front light module includes a light guide plate, a light collecting structure, and a light source. The light guide plate includes a top surface, a bottom surface, and a light incident surface connecting the top surface and the bottom surface, and at least one light extraction layer. The light collecting structure is located on at least one of the top surface and the bottom surface. The light source faces the light incident surface of the light guide plate.

In one embodiment, the light collecting structure includes multiple prism structures, and a refractive index of the light collecting structure is from 1.41 to 1.48.

In one embodiment, the light extraction layer includes multiple dot structures, and an aspect ratio of the dot structures is smaller than 0.1.

In one embodiment, a light focusing angle of the light extraction layer is in a range from 50 degrees to 70 degrees, and a fill width at half maximum of a light intensity is smaller than 15 degrees.

In one embodiment, the light collecting structure includes a light facing surface having a light facing angle from 75 degrees to 85 degrees.

In one embodiment, the light collecting structure includes a back light surface having a back light angle from 25 degrees to 45 degrees.

In one embodiment, the front light module includes a first optical adhesive layer located on the top surface of the light guide plate, wherein a refractive index difference between the first optical adhesive layer and the light guide plate is greater than 0.15 and smaller than 0.23.

In one embodiment, a refractive index of the first optical adhesive layer is in a range from 1.35 to 1.43.

In one embodiment, the front light module further includes a second optical adhesive layer located on the bottom surface of the light guide plate, wherein a refractive index difference between the second optical adhesive layer and the light guide plate is greater than 0.1 and smaller than 0.27.

In one embodiment, a refractive index of the second optical adhesive layer is in a range from 1.58 to 1.65.

Another aspect of the present disclosure is a display device.

In one embodiment, the display device includes a reflective display panel, a light guide plate, a prism structure layer, and a light source. The light guide plate includes a top surface, a bottom surface, a light incident surface connecting the top surface and the bottom surface, and at least one dot pattern layer located on at least one of the top surface and the bottom surface. The prism structure layer is located between the light guide plate and the reflective display panel. The light source faces the light incident surface of the light guide plate.

In one embodiment, a refractive index of the prism structure layer is from 1.41 to 1.48.

In one embodiment, a refractive index of the prism structure layer is smaller than a refractive index of the light guide plate.

In one embodiment, the display device includes a first optical adhesive layer located on the top surface of the light guide plate, wherein a refractive index of the first optical adhesive layer is smaller than the refractive indexes of the light guide plate and the dot pattern layer.

In one embodiment, a refractive index difference between the first optical adhesive layer and the dot pattern layer is greater than 0.15 and smaller than 0.23.

In one embodiment, the display device includes a second optical adhesive layer located on the bottom surface of the light guide plate, wherein a refractive index of the second optical adhesive layer is greater than or equal to the refractive indexes of the light guide plate and the dot pattern layer.

In one embodiment, a refractive index difference between the second optical adhesive layer and the light guide plate is greater than 0.1 and smaller than 0.27.

In one embodiment, the refractive index of the second optical adhesive layer is greater than the refractive index of the first optical adhesive layer.

In one embodiment, an aspect ratio of the dot pattern layer is smaller than 0.1.

In one embodiment, a number of the at least one dot pattern layer is plural, and the dot pattern layers are respectively located on the top surface and the bottom surface of the light guide plate.

In the aforementioned embodiments, through the configuration of the light collecting structure and the light extraction layer of the present disclosure, the second peak value is lowered to reduce light disturbance and enhance the optical performance of the display device. In addition, the light guide plate of the present disclosure can enhance the S/N ratio stability. As such, as the thickness of the light guide plate is shrunk, the disadvantages of the frequency increasing of the collisions between the edge-lit light and the micro dot structures on the light guide plate can be overcome. The dot density is not limited, and the optical performance of the display device is maintained.

### BRIEF DESCRIPTION OF THE DRAWINGS

The invention can be more fully understood by reading the following detailed description of the embodiment, with reference made to the accompanying drawings as follows:

FIG. 1 is a side view of a display device of one embodiment of the present disclosure.

FIG. 2 is a light distribution diagram according to various embodiments of the present disclosure.

FIG. 3 is a side view of a display device according to another embodiment of the present disclosure.

FIG. 4 is a light distribution diagram according to various embodiments of the present disclosure.

FIG. 5 is a relationship diagram of dot coverage ratio and S/N ratio of various embodiments.

FIG. 6 is a relationship diagram of dot coverage ratio and S/N ratio of various embodiments.

FIG. 7 is a side view of a display device according to another embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

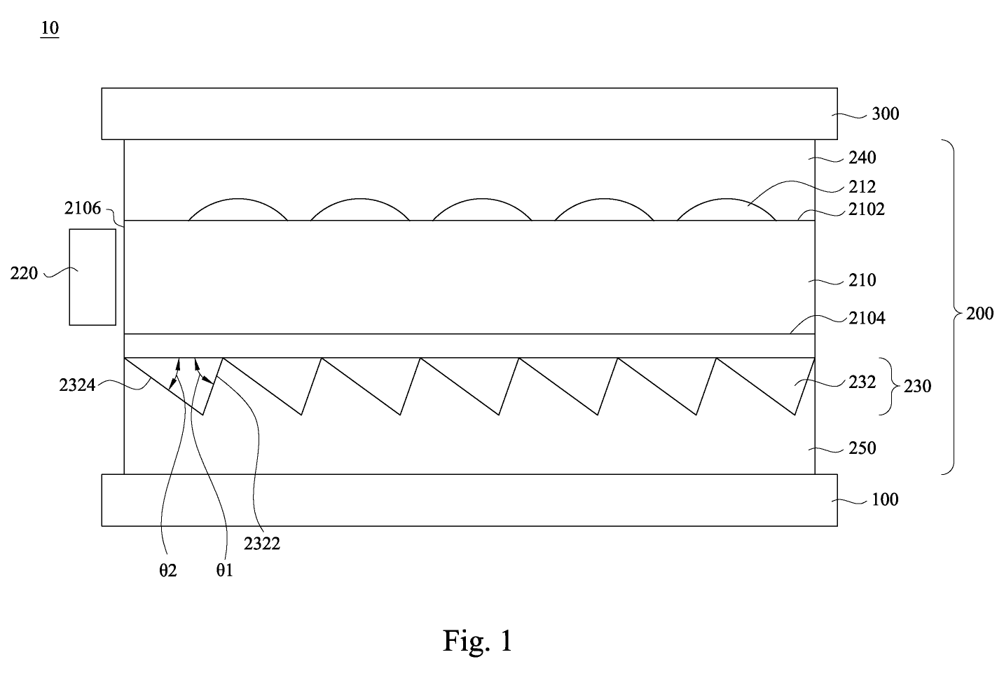

FIG. 1 is a side view of a display device 10 of one embodiment of the present disclosure. The display device 10 includes a reflective display panel 100 and a front light module 200. The front light module 200 includes a light guide plate 210, a light source 220 and a light collecting structure 230.

The light guide plate 210 includes a top surface 2102, a bottom surface 2104, and a light incident surface 2106 connecting the top surface 2102 and the bottom surface 2104. The bottom surface 2104 faces the reflective display panel 100, and the top surface 2102 is away from the reflective display panel 100. The light guide plate 210 further includes a light extraction layer 212. In the present embodiment, a number of the light extraction layer 212 is one, and the light extraction layer 212 is located on the top surface 2102, but the present disclosure is not limited thereto. The front light module 200 is an edge-lit module. The refractive index of the light guide plate 210 is about 1.58, and the refractive index of the light extraction layer 212 is about 1.58.

The light extraction layer 212 includes multiple dot structures that formed a dot pattern layer containing semi-hemisphere micro lens structures. The aspect ratio of the dot structures is smaller than 0.1, and the dot structures protrude away from the light guide plate 210. The light focusing angle of the light extraction layer 212 is in a range from 50 degrees to 70 degrees, and a full width at half maximum of a light intensity is smaller than 15 degrees. The light extraction layer 212 is configured to perform light extraction.

The light source 220 is located at a side of the light guide plate 210 and faces the light incident surface 2106. The light collecting structure 230 is located on the bottom surface 2104 of the light guide plate 210, which is between the light guide plate 210 and the reflective display panel 100. In other words, the light collecting structure 230 is located between the light extraction layer 212 and the reflective display panel 100. Since a light intensity distribution of the light passed through the light extraction layer 212 concentrates at larger angles, the light can be focused by the light collecting structure 230. The light collecting structure 230 is a prism structure layer formed by multiple prism structures 232. The refractive index of the light collecting structure 230 is smaller than the refractive index of the light guide plate 210. The refractive index of the light collecting structure 230 is between 1.41 to 1.48.

Each one of the light collecting structure 232 of the light collecting structure 230 includes a light facing surface 2322 and a back light surface 2324. The light facing surface 2322 has a light facing angle θ1 from 75 degrees to 85 degrees. The back light surface 2324 has a back light angle θ2 from 25 degrees to 45 degrees.

The front light module 200 further includes a first optical adhesive layer 240 and a second optical adhesive layer 250. The first optical adhesive layer 240 is located on the top surface 2102 of the light guide plate 210. A refractive index of the first optical adhesive layer 240 is in a range from 1.35 to 1.43. The refractive index of the first optical adhesive layer 240 is smaller than the refractive index of the light guide plate 210 and the refractive index of the light extraction layer 212. A refractive index difference between the first optical adhesive layer 240 and the light guide plate 210 and the refractive index difference between the first optical adhesive layer 240 and the light extraction layer 212 are greater than 0.15 and smaller than 0.23.

The second optical adhesive layer 250 is located on the bottom surface 2104 of the light guide plate 210. The refractive index of the second optical adhesive layer 250 is in a range from 1.58 to 1.65. The refractive index of the second optical adhesive layer 250 is greater than or equals to the refractive index of the light guide plate 210 and the refractive index of the light extraction layer 212. A refractive index difference between the second optical adhesive layer 250 and the light guide plate 210 and the refractive index difference between the second optical adhesive layer 250 and the light extraction layer 212 are greater than 0.1 and smaller than 0.27. In other words, the refractive index of the second optical adhesive layer 250 is greater than the refractive index of the first optical adhesive layer 240. The refractive indexes of the structures at two opposite sides of the light collecting structure 230 are both greater than the refractive index of the light collecting structure 230.

The display device 10 further includes a cover structure 300. For example, the cover structure 300 includes an anti-glare or anti-scratch functional coating layer. The display device 10 further includes color filter, touch module (not shown), etc.

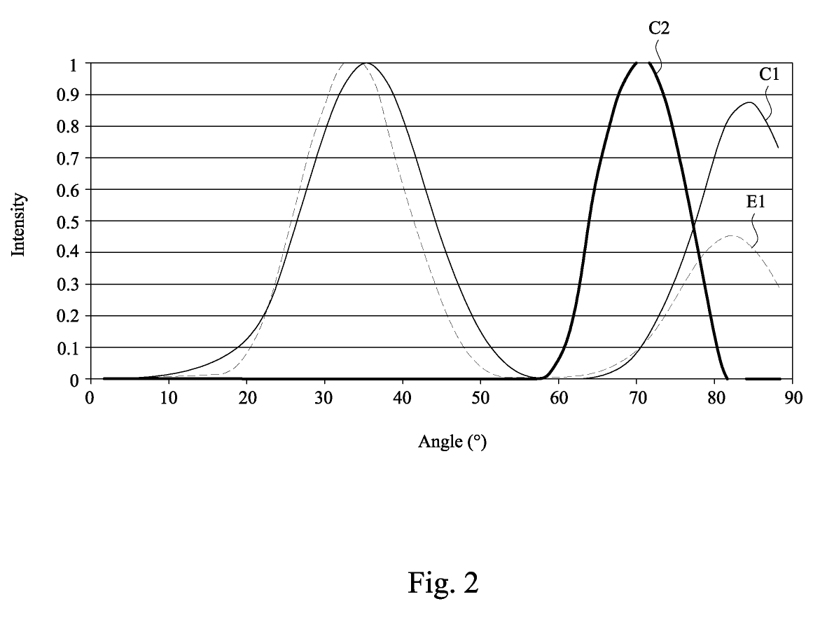

FIG. 2 is a light distribution diagram according to various embodiments of the present disclosure. The curve C1 represents the light distribution diagram after a light passed through a conventional light guide plate, which is a control group. The curve C2 represents the light distribution diagram after a light passed through the light extraction layer 212 without the light collecting structure 230 of the present disclosure, which is a control group for demonstrating the function of the light collecting structure 230. The curve E1 represents the light distribution diagram after a light passed through the display device 10 (including the light extraction layer 212 and the light collecting structure 230) of the embodiment in FIG. 1.

The traditional micro dot structures of the light guide plate are disposed facing the inner side of the light guide plate. Therefore, when the thickness of the light guide plate is shrunk, the frequency of the collisions between the edge-lit light and the micro dot structures on the light guide plate is raised. Therefore, it is necessary to lower the dot density of the micro dot structure. However, such approach may degrade optical performance of the display device. As shown by the curve C1 and the curve C2, the light extraction layer 212 concentrate the light at the region with large angles, that is, the curve C2 does not include the first peak value at about 30 degrees. As shown by the curve E1, the configuration of the light extraction layer 212 and the light collecting structure 230 can form the optical distribution with two peak values, and the second peak value is lowered to reduce light disturbance and enhance optical performance of the display device 10. Accordingly, through the configuration of the aforementioned light collecting structure 230 and the light extraction layer 212 of the present disclosure, the disadvantages of the conventional method can be overcome.

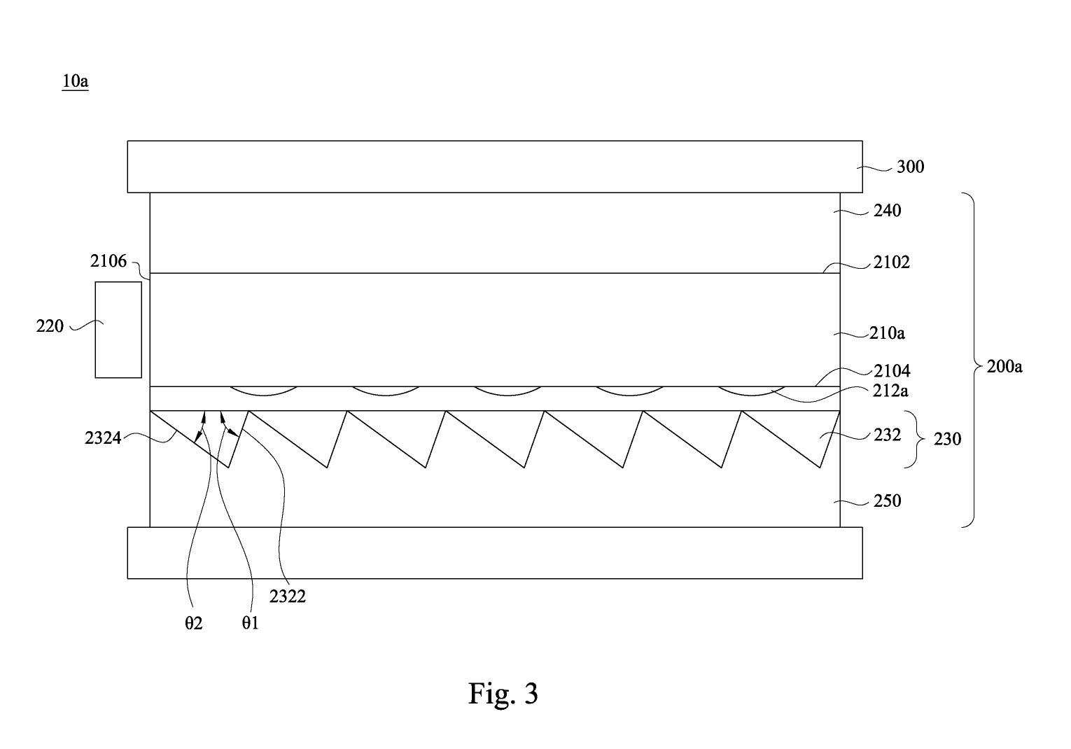

FIG. 3 is a side view of a display device 10a according to another embodiment of the present disclosure. The display device 10a is similar to the display device 10, and the difference is that the light extraction layer 212a of the light guide plate 210a of the display device 10a is located on the bottom surface 2104 of the light guide plate 210a. The display device 10a and the display device 10 have similar advantages, and therefore the description is not repeated hereinafter.

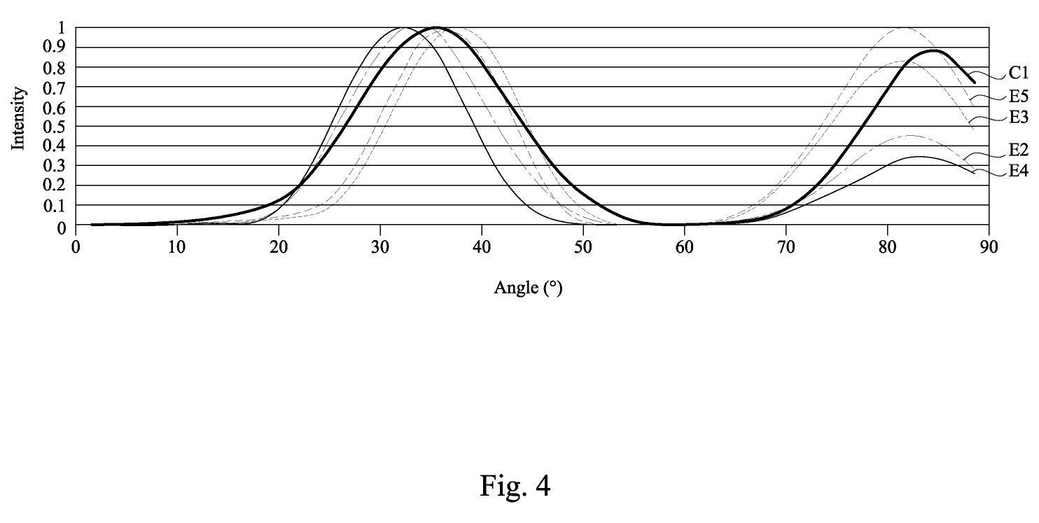

FIG. 4 is a light distribution diagram according to various embodiments of the present disclosure. The curve C1 represents the light distribution diagram after a light passed through a conventional light guide plate, which is a control group. The curve E2 represents the light distribution diagram after a light passed through the display device 10a shown in FIG. 2, and the refractive index of the light collecting structure 230 is 1.41. The curve E3 represents the light distribution diagram after a light passed through the display device 10a shown in FIG. 2, and the refractive index of the light collecting structure 230 is 1.48. The curve E4 represents the light distribution diagram after a light passed through the display device 10 shown in FIG. 1, and the refractive index of the light collecting structure 230 is 1.41. The curve E5 represents the light distribution diagram after a light passed through the display device 10 shown in FIG. 1, and the refractive index of the light collecting structure 230 is 1.48. It can be seen from the comparisons of the curve C1 and the curves E1~E4, the difference between the light intensities of these four embodiments is not obvious, and the second peak values of the curve E2 and the curve E4 are lower obviously. Accordingly, the position of the light extraction layer 212 does not influence the optical distribution. The refractive index of the light collecting structure 230 is 1.41 in the preferred embodiment and has better ability to reduce disturbance.

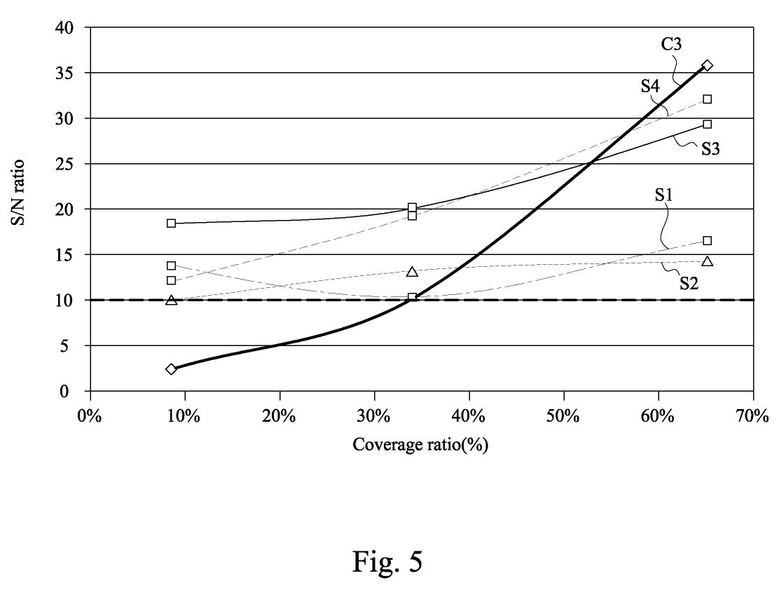

FIG. 5 is a relationship diagram of dot coverage ratio and S/N ratio of various embodiments. A light guide plate with 50 micrometers thickness is demonstrated herein as an example. The curve C3 represents the light distribution diagram after a light passed through a conventional light guide plate, which is a control group. The curve S1 represents the light distribution diagram after a light passed through the display device 10 in FIG. 1, and the aspect ratio of the light extraction layer 212 is 0.012. The curve S2 represents the light distribution diagram after a light passed through the display device 10a in FIG. 2, and the aspect ratio of the light extraction layer 212 is 0.012. The curve S3 represents the light distribution diagram after a light passed through the display device 10 in FIG. 1, and the aspect ratio of the light extraction layer 212 is 0.05. The curve S4 represents the light distribution diagram after a light passed through the display device 10a in FIG. 2, and the aspect ratio of the light extraction layer 212 is 0.05. It can be seen from the comparisons of the curve C3 and the curves S1~S4, the S/N ratio of these four embodiments are greater than 10 with any coverage ratio, which are more stable than the control group. Accordingly, the dot density is not limited through the light guide plate design of the present disclosure.

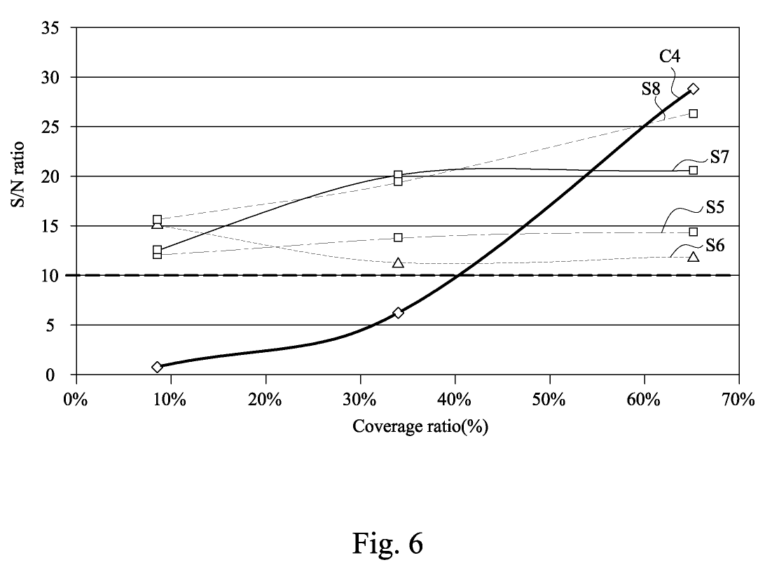

FIG. 6 is a relationship diagram of dot coverage ratio and S/N ratio of various embodiments. A light guide plate with 150 micrometers thickness is demonstrated herein as an example. The curve C4 represents the light distribution diagram after a light passed through a conventional light guide plate, which is a control group. The curve S5 represents the light distribution diagram after a light passed through the display device 10 in FIG. 1, and the aspect ratio of the light extraction layer 212 is 0.012. The curve S6 represents the light distribution diagram after a light passed through the display device 10a in FIG. 2, and the aspect ratio of the light extraction layer 212 is 0.012. The curve S7 represents the light distribution diagram after a light passed through the display device 10 in FIG. 1, and the aspect ratio of the light extraction layer 212 is 0.05. The curve S8 represents the light distribution diagram after a light passed through the display device 10a in FIG. 2, and the aspect ratio of the light extraction layer 212 is 0.05. It can be seen from the comparisons of the curve C4 and the curves S5~S8, the S/N ratio of these four embodiments are greater than 10 with any coverage ratio, which are more stable than the control group. Accordingly, it is noted that the dot density is not limited through the light guide plate design of the present disclosure through the embodiments of the FIG. 5 and the FIG. 6.

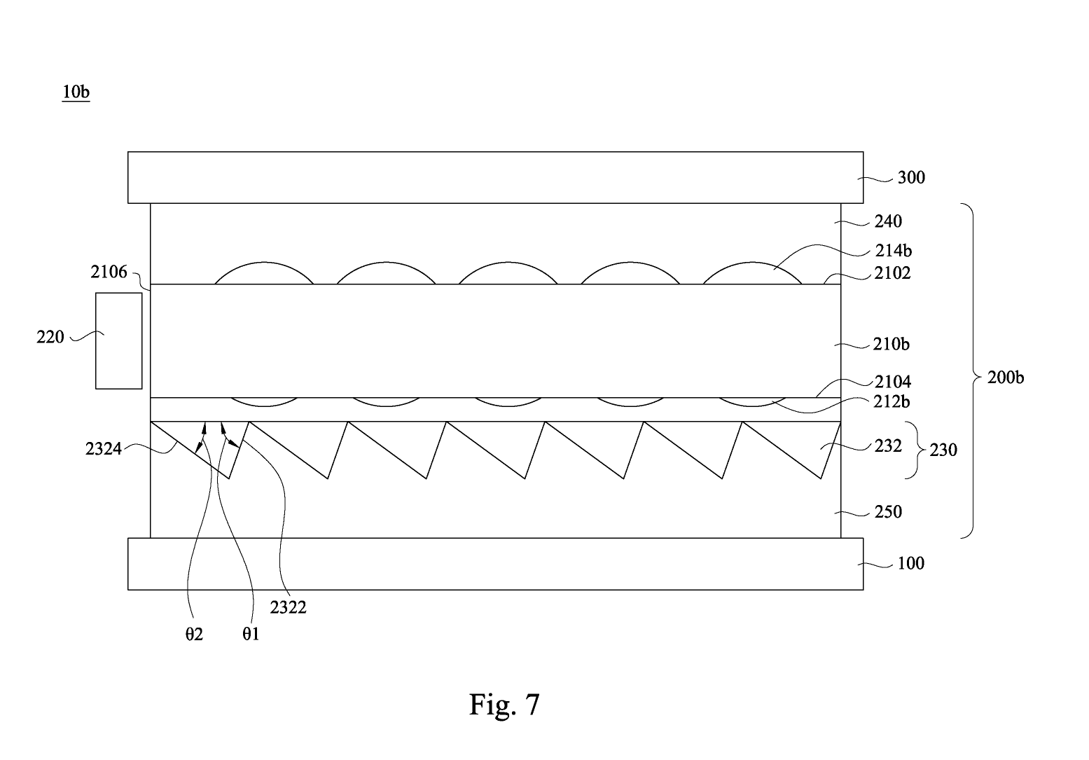

FIG. 7 is a side view of a display device 10b according to another embodiment of the present disclosure. The display device 10b is similar to the display device 10, and the difference is that the light guide plate 210b of the display device 10b includes two light extraction layers 212b, 214b located on the top surface 2102 and the bottom surface 2104 of the light guide plate 210b respectively. The display device 10b and the display device 10 have similar advantages, and therefore the description is not repeated hereinafter.

In summary, through the configuration of the light collecting structure and the light extraction layer of the present disclosure, the second peak value is lowered to reduce the light disturbance and enhance the optical performance of the display device. In addition, the light guide plate of the present disclosure can enhance the S/N ratio stability. As such, when the thickness of the light guide plate is shrunk, the disadvantages of the frequency increasing of the collisions between the edge-lit light and the micro dot structures on the light guide plate can be overcome. The dot density is not limited, and the optical performance of the display device is maintained.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A front light module, comprising:
a light guide plate, comprising:
a top surface;
a bottom surface;
a light incident surface connecting the top surface and the bottom surface; and
at least one light extraction layer;
a light collecting structure located on at least one of the top surface and the bottom surface; and
a light source facing the light incident surface of the light guide plate.

2. The front light module of claim 1, wherein the light collecting structure comprises a plurality of prism structures, and a refractive index of the light collecting structure is from 1.41 to 1.48.

3. The front light module of claim 1, wherein the light extraction layer comprises a plurality of dot structures, and an aspect ratio of the dot structures is smaller than 0.1.

4. The front light module of claim 1, wherein a light focusing angle of the light extraction layer is in a range from 50 degrees to 70 degrees, and a fill width at half maximum of a light intensity is smaller than 15 degrees.

5. The front light module of claim 1, wherein the light collecting structure comprises a light facing surface having a light facing angle from 75 degrees to 85 degrees.

6. The front light module of claim 1, wherein the light collecting structure comprises a back light surface having a back light angle from 25 degrees to 45 degrees.

7. The front light module of claim 1, further comprising:
a first optical adhesive layer located on the top surface of the light guide plate, wherein a refractive index difference between the first optical adhesive layer and the light guide plate is greater than 0.15 and smaller than 0.23.

8. The front light module of claim 7, wherein a refractive index of the first optical adhesive layer is in a range from 1.35 to 1.43.

9. The front light module of claim 1, further comprising:
a second optical adhesive layer located on the bottom surface of the light guide plate, wherein a refractive index difference between the second optical adhesive layer and the light guide plate is greater than 0.1 and smaller than 0.27.

10. The front light module of claim 9, wherein a refractive index of the second optical adhesive layer is in a range from 1.58 to 1.65.

11. A display device, comprising:
a reflective display panel;
a light guide plate, comprising:
a top surface;
a bottom surface;
a light incident surface connecting the top surface and the bottom surface; and
at least one dot pattern layer located on at least one of the top surface and the bottom surface; and
a prism structure layer located between the light guide plate and the reflective display panel; and
a light source facing the light incident surface of the light guide plate.

12. The display device of claim 11, wherein a refractive index of the prism structure layer is from 1.41 to 1.48.

13. The display device of claim 11, wherein a refractive index of the prism structure layer is smaller than a refractive index of the light guide plate.

14. The display device of claim 11, further comprising:
a first optical adhesive layer located on the top surface of the light guide plate, wherein a refractive index of the first optical adhesive layer is smaller than the refractive indexes of the light guide plate and the dot pattern layer.

15. The display device of claim 14, wherein a refractive index difference between the first optical adhesive layer and the dot pattern layer is greater than 0.15 and smaller than 0.23.

16. The display device of claim 14, further comprising:
a second optical adhesive layer located on the bottom surface of the light guide plate, wherein a refractive index of the second optical adhesive layer is greater than or equal to the refractive indexes of the light guide plate and the dot pattern layer.

17. The display device of claim 16, wherein a refractive index difference between the second optical adhesive layer and the light guide plate is greater than 0.1 and smaller than 0.27.

18. The display device of claim 16, wherein the refractive index of the second optical adhesive layer is greater than the refractive index of the first optical adhesive layer.

19. The display device of claim 11, wherein an aspect ratio of the dot pattern layer is smaller than 0.1.

20. The display device of claim 11, wherein a number of the at least one dot pattern layer is plural, and the dot pattern layers are respectively located on the top surface and the bottom surface of the light guide plate.
